(19) United States
(12) Patent Application Publication
(10) Pub. No.: US 2014/0354627 A1
(43) Pub. Date: Dec. 4, 2014

(54) RENDERING A 3D SHAPE

(71) Applicant: Konica Minolta Labratory U.S.A., Inc., San Mateo, CA (US)

(72) Inventor: Glenn L. Pinkerton, Lafayette, CO (US)

(21) Appl. No.: 13/907,730

(22) Filed: May 31, 2013

(51) Int. Cl. G06T 15/50

(52) U.S. Cl. CPC G06T 15/50
USPC 345/419

(57) ABSTRACT

A method for rendering a three-dimensional (3D) shape, including: obtaining an electronic document (ED) specifying the 3D shape; generating a two-dimensional (2D) polygon by projecting the 3D shape onto a 2D plane; selecting multiple control points on a surface of the 3D shape; calculating multiple normal vectors orthogonal to the surface at the multiple control points; determining multiple coordinates by projecting the multiple control points onto the 2D plane; fitting a polynomial based on at least the multiple coordinates and the normal vectors; applying a 3D lighting effect to the 2D polygon based on the polynomial; and outputting the 2D polygon with the 3D lighting effect.

### BACKGROUND

In a two dimensional (2D) rendering of a three dimensional (3D) object, such as a 3D chart, traditional methods typically render the 3D object by generating a fairly large number of triangles which are used to make a piecewise linear approximation of the surface of the 3D object. The lighting effects and/or colors are distributed across each triangle using interpolation techniques. However, this can be computationally expensive on the rendering device. Regardless, users still wish to execute 2D renderings of 3D objects on all types of devices.

### SUMMARY

In general, in one aspect, the invention relates to a method for rendering a three-dimensional (3D) shape. The method comprises: obtaining an electronic document (ED) specifying the 3D shape; generating a two-dimensional (2D) polygon by projecting the 3D shape onto a 2D plane; selecting a plurality of control points on a surface of the 3D shape; calculating a plurality of normal vectors orthogonal to the surface at the plurality of control points, wherein each of the plurality of normal vectors comprises a first dimension, a second dimension, and a third dimension; determining a plurality of coordinates by projecting the plurality of control points onto the 2D plane; fitting a first polynomial based on at least the plurality of coordinates and the plurality of normal vectors; applying a 3D lighting effect to the 2D polygon based on the first polynomial; and outputting the 2D polygon with the 3D lighting effect.

In general, in one aspect, the invention relates to a non-transitory computer readable medium (CRM) storing a plurality of instructions for rendering a three-dimension (3D) shape. The instructions comprise functionality for: obtaining an electronic document (ED) specifying a three-dimensional (3D) shape; generating a two-dimensional (2D) polygon by projecting the 3D shape onto a 2D plane; selecting a plurality of control points on a surface of the 3D; calculating a plurality of normal vectors orthogonal to the surface at the plurality of control points, wherein each of the plurality of normal vectors comprises a first dimension, a second dimension, and a third dimension; determining a plurality of coordinates by projecting the plurality of control points onto the 2D plane; fitting a first polynomial based on at least the plurality of coordinates and the plurality of normal vectors; applying 3D lighting effect to the 2D polygon based on the first polynomial; and outputting the 2D polygon with the 3D lighting effect.

In general, in one aspect, the invention relates to a system for rendering a three dimensional (3D) shape. The system comprises: a computer processor; a buffer configured to store an electronic document (ED) specifying the ED shape; a control points module configured to: generate a two-dimensional (2D) polygon by projecting the 3D shape onto a 2D plane; determine a plurality of control points on the surface of the 3D shape based on the 2D polygon; calculate a plurality of normal vectors orthogonal to the surface at the plurality of control points, wherein each of the plurality of normal vectors comprises a first dimension, a second dimension, and a third dimension; and determine a plurality of coordinates by projecting the plurality of control points onto the 2D plane; a polynomial engine configured to fit a first polynomial based on at least the plurality of coordinates and the plurality of normal vectors; and a rendering engine executing on the computer processor and configured to apply a 3D lighting effect to the 2D polygon based on the first polynomial.

Other aspects of the invention will be apparent from the following description and the appended claims.

### BRIEF DESCRIPTION OF DRAWINGS

FIG. 1 shows a system in accordance with one or more embodiments of the invention.

FIGS. 2-4 show flowcharts in accordance with one or more embodiments of the invention.

FIGS. 5, 6A-C, and 7 show examples in accordance with one or more embodiments of the invention.

FIG. 8 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to a system and method for rendering a 3D shape. Specifically, the 3D shape is projected onto a 2D plane creating a 2D polygon. Multiple control points are selected on the surface of the 3D shape based on a default or specified 3D view. Moreover, a normal vector orthogonal to the surface of the 3D shape is calculated for each control point. The control points are also projected onto the 2D plane.

In one or more embodiments of the invention, the multiple normal vectors and a default or specified light source model are used to calculate a sample brightness factor for each of the projected control points. Further, a polynomial is then fit based on the sample brightness factors and the coordinates of the projected control points. The resulting polynomial function may then be used to evaluate the brightness factor over the entire area of the 2D polygon. A 3D lighting effect is applied to the 2D polygon by modifying the base color of the 2D polygon's pixels according to the brightness factors evaluated at the pixels.

In one or more embodiments of the invention, each dimension (e.g., x, y, z) of the normal vectors is used to fit a polynomial. Accordingly, three polynomials may be fit based on the normal vectors and the coordinates of the projected control points. The three polynomials may be evaluated at various pixels of the 2D polygon to create a surface vector for the pixel. Further, the surface vector and a default or specified light source model may be used to calculate a brightness factor for the pixel. A 3D lighting effect is applied to the 2D polygon by modifying the base color of the pixel according to the brightness factor.

In one or more embodiments of the invention, the multiple normal vectors and a default or specified light source model are used to calculate a sample brightness factor for each of the projected control points. The sample brightness factor at each projected control point is then used to calculate multiple sample color component modification factors (CCMFs). For example, if a red-green-blue (RGB) color model is being used, 3 sample CCMFs are calculated based on the sample brightness factor at each project control point. Multiple polynomials, one for each color component, are fit based on the sample CCMFs and the coordinates of the projected control points. A 3D lighting effect is applied to the 2D polygon by modifying the base color of the 2D polygon's pixels according to the CCMFs obtained from evaluating the multiple polynomials at the pixels.

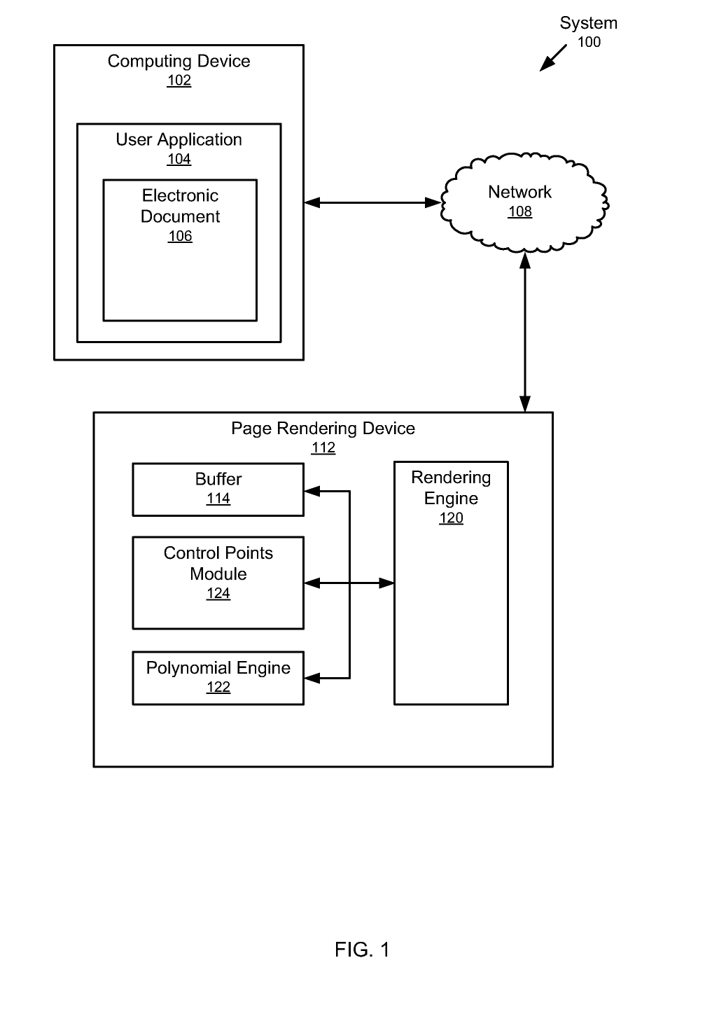

FIG. 1 shows a system (100) in accordance with one or more embodiments of the invention. As shown in FIG. 1, the system (100) has multiple components including a page rendering device (PRD) (112) and a computing device (102). The PRD (112) and/or the computing device (102) may be a personal computer (PC), a desktop computer, a mainframe, a server, a telephone, a kiosk, a cable box, a personal digital assistant (PDA), an electronic reader, a mobile phone, a smart phone, a tablet computer, a multi-function printer, a stand alone printer, etc. The PRD (112) and/or the computing device (102) may include a display device (e.g., a monitor, screen, etc.) for displaying the rendered electronic document (ED). In one or more embodiments of the invention, there exists a direct connection (e.g., universal serial bus (USB) connection) between the computing device (102) and the PRD (112). Alternatively, the computing device (102) and the PRD (112) may be connected using a network (108) of any size having wired and/or wireless segments.

In one or more embodiments of the invention, the PRD (112) is located on the computing device (102). In such embodiments, the PRD (112) may correspond to any combination of hardware and software on the computing device (102) for rendering the ED.

In one or more embodiments of the invention, the computing device (102) executes the user application (104). The user application (104) is a software application operated by a user and configured to obtain, input, generate, display, and/or print an ED. Accordingly, the user application (104) may be a word-processing application, a spreadsheet application, a desktop publishing application, a graphics application, a photograph printing application, an Internet browser, a slide show generating application, a form, etc. The user application (104) may generate new EDs and/or obtain previously saved EDs.

In one or more embodiments of the invention, the ED (106) includes one or more 3D shapes to be displayed on or across one or more pages. The 3D shape may correspond to spheres, cones, cylinders, ellipsoids, and other 3D shapes having smooth simple convex surfaces. Moreover, the 3D shape may be a partial approximation of a larger 3D object (e.g., charts). In other words, multiple 3D shapes of various sizes may be needed to adequately approximate the whole 3D object.

In one or more embodiments of the invention, the ED (106) is represented/defined using a document markup language (e.g., open document format (ODF), office open XML (OOXML), etc.). Accordingly, both the 3D shape(s) and the parameter(s) needed to create/define/specify a 3D lighting effect (i.e., the light source model(s), the base color(s), 3D view(s), etc.) may be recorded/identified/specified as attributes within the tags of the document markup language. These attributes are needed to correctly render the ED (106) including the 3D shape(s) for display or printing.

In one or more embodiments of the invention, the PRD (112) includes a buffer (114), a rendering engine (120), a polynomial engine (122), and a control points module (CPM) (124). Each of these components is discussed below. In one or more embodiments of the invention, the buffer (114) is configured to store the ED (106) received from the computing device (102). Accordingly, the buffer (114) may correspond to any type of memory or long-term storage (e.g., hard drive). Moreover, the buffer (114) may store the ED (106) in its entirety, or the buffer (114) may store only a segment of the of the ED (106) at any given time. The buffer (114) may further be configured to parse the ED (106).

In one or more embodiments of the invention, the CPM (124) is configured to generate a 2D polygon by projecting a 3D shape specified in the ED (106) onto a 2D plane according to a default 3D view or a 3D view specified in the ED (106). Further, the CPM (124) may be configured to select control points on the surface of the 3D shape based on the 3D view and the 2D polygon. For example, control points may be selected such that the projections of the control points onto the 2D plane are uniformly distributed across the 2D polygon. Further still, the CPM (124) may also be configured to calculate/determine the coordinates on the 2D plane of the projected control points.

In one or more embodiments of the invention, the CPM (124) is configured to calculate normal vectors orthogonal to the surface of the 3D shape at each control point. The normal vector may be calculated using the known geometry and geometric properties of the 3D shape. The normal vector to the surface of the 3D shape may also be calculated using known calculus techniques, for example using the gradient of a function that represents the surface of the 3D shape. Those skilled in the art, having the benefit of this detailed description, will appreciate that each normal vector has multiple vector components, with each component corresponding to a different dimension (e.g., x-dimension, y-dimension, z-dimension).

In one or more embodiments of the invention, the CPM (124) is configured to calculate sample brightness factors for the multiple control points. Specifically, the sample brightness factors are calculated using the normal vectors and a default light source model (e.g., a point source) or a light source model specified in the ED (106). For example, the sample brightness factor at a control point may be calculated by executing a dot product of the normal vector at the control point with the light source model.

In one or more embodiments of the invention, the CPM (124) is configured to calculate sample CCMFs for each of the projected control points. Specifically, sample brightness factors are calculated for the control points using the normal vectors and a default light source model or a light source module specified in the ED (106). Then, the CCMFs at each control point are calculated from the brightness factor at the control point. The number of CCMFs at a control point (or projected control point) depends on the color model being used. For example, in the red-green-blue (RGB) color model, there are three CCMFs for each projected control point: one for the red color component, one for the green color component, and one for the blue color component. Other color models (e.g., CMYK) may also be used.

In one or more embodiments, the polynomial engine (122) is configured to fit a single polynomial based on the coordinates of the projected control points and the sample brightness factors calculated at the control points. The resulting polynomial function may then be used to evaluate the brightness factor over the entire area of the 2D polygon. The polynomials may be of any type including biquadratic or bicubic polynomial functions. Further, the polynomial engine (122) may determine the accuracy of the polynomial fit using known techniques, such as standard deviation, etc.

In one or more embodiments of the invention, the polynomial engine (122) is configured to fit multiple polynomials based on the coordinates of the projected control points and the normal vectors calculated at the control points. Specifically, the polynomial engine (122) may fit three polynomials, each corresponding to a different dimension (e.g., x, y, or z) of the normal vectors. The resulting polynomial functions may then be used to evaluate the surface vector over the entire area of the 2D polygon. The polynomials may be of any type including biquadratic or bicubic polynomial functions. Further, the polynomial engine (122) may determine the accuracy of the polynomial fit using known techniques, such as standard deviation, etc.

In one or more embodiments of the invention, the polynomial engine (122) is configured to fit multiple polynomials based on the coordinates of the projected control points and the CCMFs for the project control points. Specifically, the polynomial engine (122) may fit one polynomial for each color component. For example, in the case of the RGB color model, the polynomial engine (122) may fit three polynomials: one polynomial for the red color component modification, one polynomial for the green color component modification, and one polynomial for the blue color component modification. The resulting polynomial functions may then be used to obtain CCMFs over the entire area of the 2D polygon. The polynomials may be of any type including biquadratic or bicubic polynomial functions. Further, the polynomial engine (122) may determine the accuracy of the polynomial fit using known techniques, such as standard deviation, etc.

In one or more embodiments of the invention, the rendering engine (120) is configured to apply a 3D lighting effect to the 2D polygon using at least one of the fitted polynomials. Specifically, the rendering engine (120) may evaluate the single polynomial at various pixels corresponding to the 2D polygon to obtain brightness factors for the pixels. The base colors of these pixels are then modified according to the brightness factors to create the 3D lighting effect. The polygon with the applied 3D lighting effect is a 2D rendering of the 3D shape, and can now be output to a display, a file, and/or a printer.

In one or more embodiments of the invention, the rendering engine (120) is configured to apply a 3D lighting effect to the 2D polygon using at least one of the fitted polynomials. Specifically, the rendering engine (120) may evaluate the three polynomials (each of the three polynomials corresponding to a different dimension) at various pixels corresponding to the 2D polygon to obtain surface vectors for the pixels. The rendering engine (120) may also calculate brightness factors for the pixels using the surface vectors and a light source model. The base colors of these pixels are then modified according to the brightness factors to create the 3D lighting effect. The polygon with the applied 3D lighting effect is a 2D rendering of the 3D shape, and can now be output to a display, a file, and/or a printer.

In one or more embodiments of the invention, the rendering engine (120) is configured to apply a 3D lighting effect to the 2D polygon using at least one of the fitted polynomials. Specifically, the rendering engine (120) may evaluate the three polynomials (each of the three polynomials corresponding to modification factors for a different color component) at various pixels corresponding to the 2D polygon to obtain CCMFs for the pixels. By obtaining the CCMFs from the fitted polynomials, and then applying the CCMFs to the base color(s) of the pixels, the 3D lighting effect is applied. The polygon with the applied 3D lighting effect is a 2D rendering of the 3D shape, and can now be output to a display, a file, and/or a printer.

Those skilled in the art, having the benefit of this detailed description, will appreciate that polynomials need not be evaluated at every pixel corresponding to the 2D polygon. For example, the surface vectors, the brightness factors, and/or the color values for every 4th pixel in x-direction and the y-direction may be calculated. The surface vectors, the brightness factors, and/or the color values for the remaining pixels in the 4 by 4 cell may be calculated using bilinear interpolation of the 4 corner points. Other known interpolation techniques may also be used.

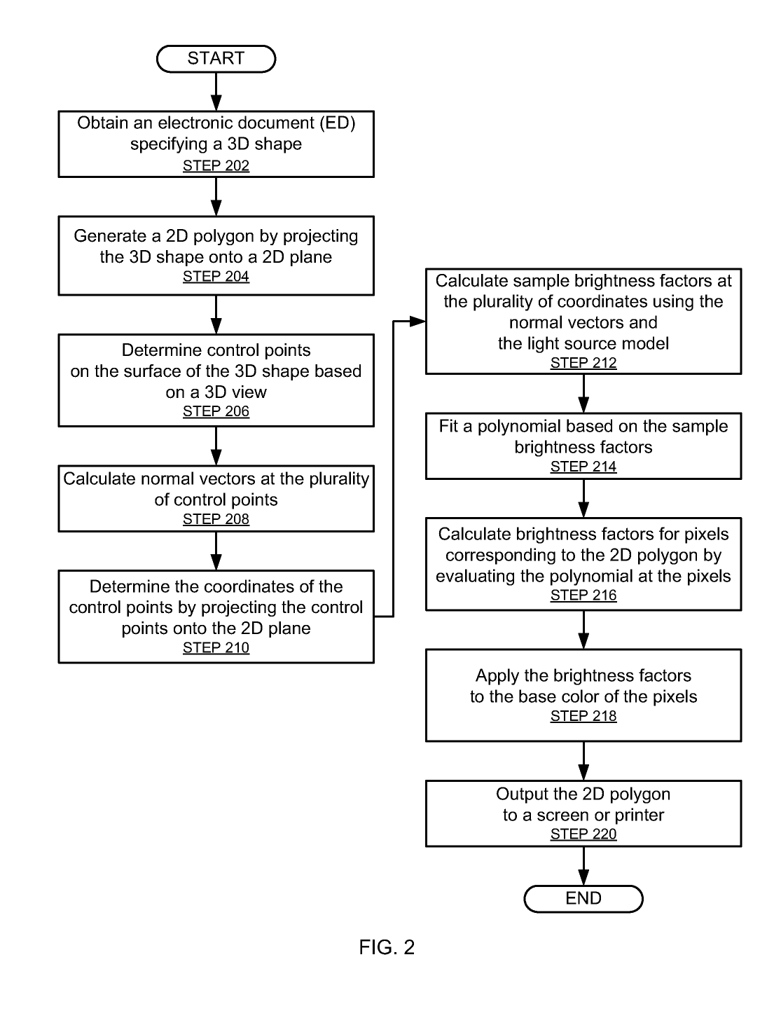

FIG. 2 shows a flowchart in accordance with one or more embodiments of the invention. The process shown in FIG. 2 may be executed, for example, by one or more components (e.g., control points module (124), polynomial engine (122), rendering engine (120)) discussed above in reference to FIG. 1. One or more steps shown in FIG. 2 may be omitted, repeated, and/or performed in a different order among different embodiments of the invention. Accordingly, embodiments of the invention should not be considered limited to the specific number and arrangement of steps shown in FIG. 2.

Initially, an ED is obtained (STEP 202). The ED specifies at least one 3D shape. The 3D shape may be a sphere, a cone, a cylinder, or any other 3D shape having a smooth convex surface. The 3D shape may be a partial approximation of a larger 3D object (e.g., 3D chart). The ED may also specify a 3D view, a base color, and/or a light source model. The 3D view, the base color, and/or the light source model are used to define a 3D lighting effect and generate a 2D rendering of the 3D shape. Moreover, both the 3D shape and these properties may be recorded/identified/specified as attributes within the tags of the ED.

In STEP 204, a 2D polygon is generated. The 2D polygon is generated by projecting the 3D shape onto a 2D plane. The transformation matrix governing the projection is calculated based on the 3D view specified in the ED. If no 3D view is specified in the ED, a default 3D view may be used.

In STEP 206, control points are selected on the surface of the 3D shape. The control points may be selected based on the 3D view. The control points may be selected such that the projection of the control points onto the 2D plane are evenly distributed across the 2D polygon. Other distributions are also possible.

In STEP 208, normal vectors at the control points are calculated. The normal vectors are orthogonal to the surface of the 3D shape at the control points. The normal vector may be calculated using the known geometry and geometric properties of the 3D shape. The normal vector to the surface of the 3D shape may be calculated using known calculus techniques, for example using the gradient of a function that represents the surface of the 3D shape. Those skilled in the art, having the benefit of this detailed description, will appreciate that each normal vector has multiple vector components, with each vector component corresponding to a different dimension (e.g., x-dimension, y-dimension, z-dimension). Other coordinate systems (e.g., cylindrical coordinates, spherical coordinates, etc.) may also be used.

In STEP 210, a set of coordinates is determined by projecting the multiple control points onto the 2D plane. The control points may be projected using the same transformation matrix discussed above. Depending on the 2D plane and the coordinate system, each of the projected control points may be fully described using, for example, only an x-coordinate and a y-coordinate.

In STEP 212, a sample brightness factor is calculated at each of the control points. The sample brightness factor may be calculated using the normal vector at the control point and a light source model specified in the ED. Specifically, the sample brightness factor may correspond to the dot product of the normal vector and the light source model. If no light source model is specified in the ED, a default light source model may be used.

In STEP 214, a single polynomial is fit based on the multiple sample brightness factors and the coordinates of the corresponding projected control points. The resulting polynomial function may then be used to evaluate the brightness factor over the entire area of the 2D polygon. The polynomial may be of any type including a biquadratic or a bicubic polynomial function. Further, the accuracy of the polynomial fit may be determined using known techniques, such as standard deviation, etc.

In STEP 216, the brightness factors at multiple pixels corresponding to the 2D polygon are calculated. Specifically, the brightness factor of a pixel corresponding to the 2D polygon is calculated by evaluating the polynomial (STEP 214) at the pixel. The polynomial need not be evaluated at every pixel corresponding to the 2D polygon. In one or more embodiments of the invention, an interpolation operation is executed to determine the brightness factor of a pixel from the brightness factors of one or more adjacent or neighboring pixels.

In STEP 218, the brightness factors are applied to the base color(s) of the pixels. This may include modifying the color components of the base color(s). The base color(s) may be specified in the ED. If a base color is not specified in the ED, a default base color may be used. Those skilled in the art, having the benefit of this detailed description, will appreciate that modifying the color components of the base color(s) based on the brightness factors effectively applies a 3D lighting effect to the 2D polygon.

In STEP 220, the polygon is now a 2D rendering of the 3D shape. Accordingly, the 2D polygon may be output to a screen, a printer, and/or a file.

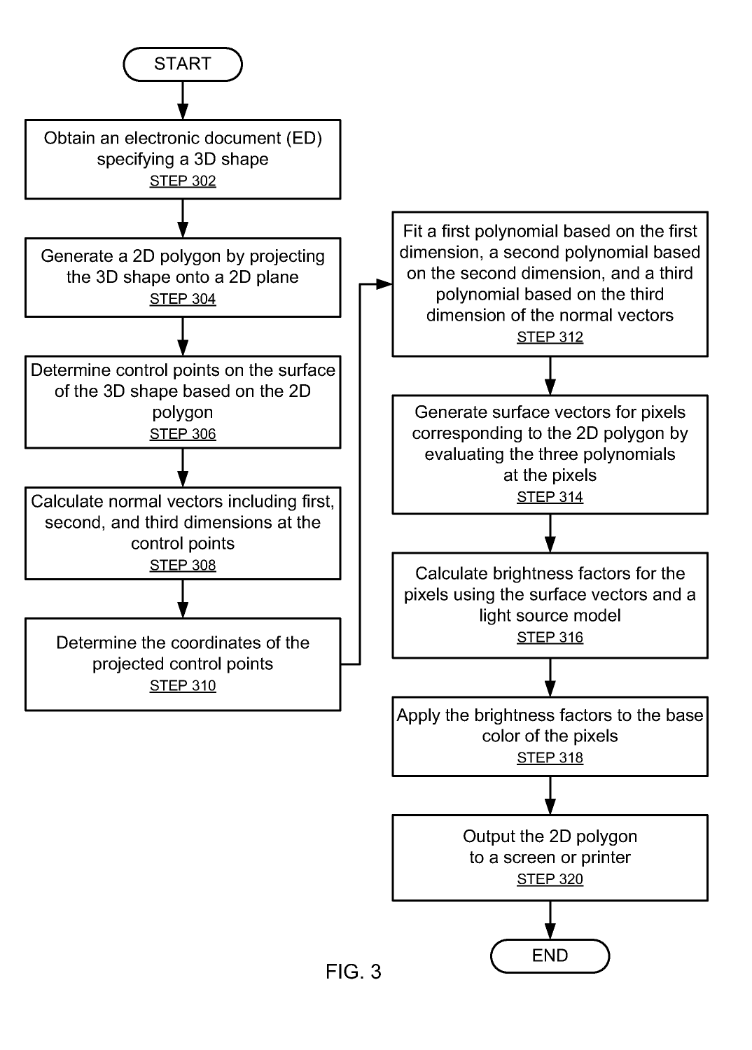

FIG. 3 shows a flowchart in accordance with one or more embodiments of the invention. The process shown in FIG. 3 may be executed, for example, by one or more components (e.g., control points module (124), polynomial engine (122), rendering engine (120)) discussed above in reference to FIG. 1. One or more steps shown in FIG. 3 may be omitted, repeated, and/or performed in a different order among different embodiments of the invention. Accordingly, embodiments of the invention should not be considered limited to the specific number and arrangement of steps shown in FIG. 3.

In one or more embodiments of the invention, STEP 302, STEP 304, STEP 306, STEP 308, and STEP 310 are essentially the same as STEP 202, STEP 204, STEP 206, STEP 208, and STEP 210, respectively, discussed above in reference to FIG. 2.

In STEP 312, multiple polynomials are fit based on the normal vectors and the coordinates of the corresponding projected control points. As discussed above, each normal vector has 3 vector components/dimensions (e.g., x, y, and z) and thus 3 polynomials may be fit. Each polynomial is fit using one dimension of the normal vectors. The resulting polynomial functions may then be used to evaluate the surface vector over the entire area of the 2D polygon. The polynomials may be of any type including biquadratic or bicubic polynomial functions. Further, the accuracy of the polynomial fit may be determined using known techniques, such as standard deviation, etc.

In STEP 314, the surface vectors at multiple pixels corresponding to the 2D polygon are calculated. Each surface vector will be approximately orthogonal to the 3D surface at the pixel. Specifically, the surface vector of a pixel is calculated by evaluating the three polynomials (STEP 312) at the pixel. The output of each polynomial is one of the surface vector's components. The polynomials need not be evaluated at every pixel corresponding to the 2D polygon. In one or more embodiments of the invention, an interpolation operation is executed to determine the surface vector of a pixel from the surface vectors of one or more adjacent or neighboring pixels.

In STEP 316, brightness factors at multiple pixels corresponding to the 2D polygon are calculated. Specifically, the brightness factor of a pixel is calculated using the surface vector of the pixel and a light source model specified in the ED. A default light source model may be used if one is not specified in the ED. In one or more embodiments of the invention, the brightness factor is the dot product of the surface vector with the light source model. In one or more embodiments of the invention, an interpolation operation is executed to determine the brightness factor of a pixel from the brightness factors of one or more adjacent or neighboring pixels.

In STEP 318, the brightness factors are applied to the base color(s) of the pixels. This may include modifying the color components of the base color(s). The base color(s) may be specified in the ED. If a base color is not specified in the ED, a default base color may be used. Those skilled in the art, having the benefit of this detailed description, will appreciate that modifying the color components of the base color(s) based on the brightness factors effectively applies a 3D lighting effect to the 2D polygon.

In STEP 320, the polygon is now a 2D rendering of the 3D shape. Accordingly, the 2D polygon may be output to a screen, a printer, and/or a file.

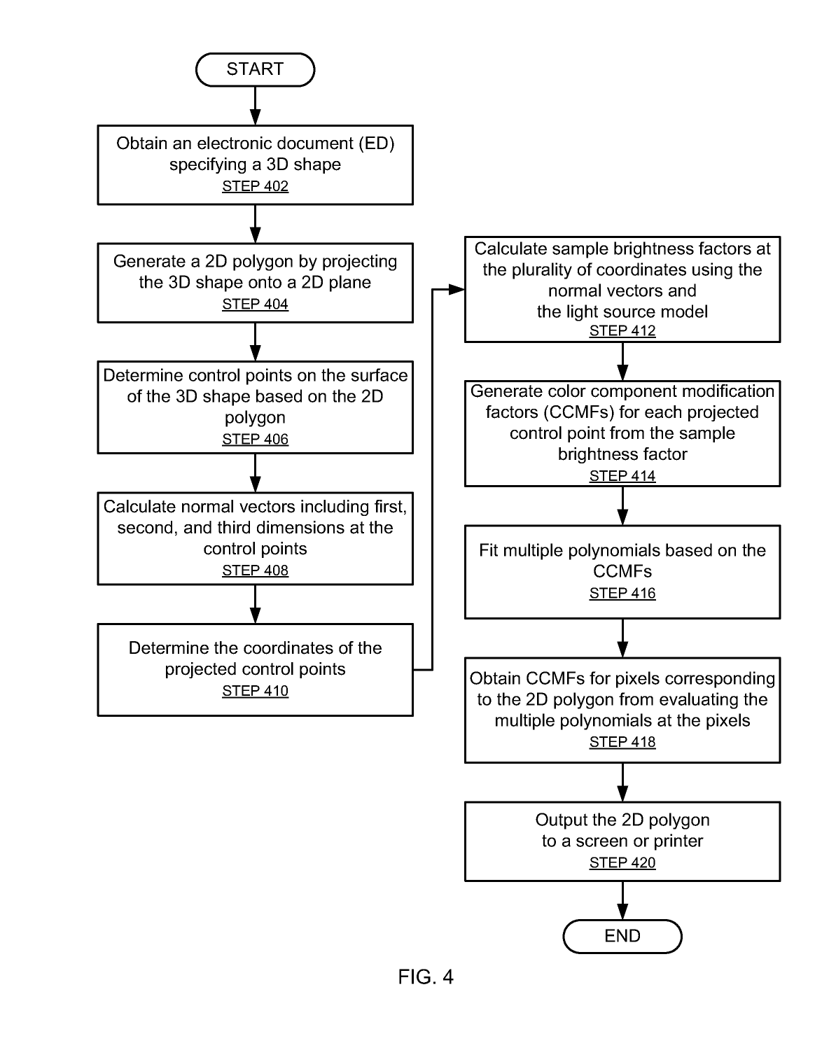

FIG. 4 shows a flowchart in accordance with one or more embodiments of the invention. The process shown in FIG. 4 may be executed, for example, by one or more components (e.g., control points module (124), polynomial engine (122), rendering engine (120)) discussed above in reference to FIG. 1. One or more steps shown in FIG. 4 may be omitted, repeated, and/or performed in a different order among different embodiments of the invention. Accordingly, embodiments of the invention should not be considered limited to the specific number and arrangement of steps shown in FIG. 4.

In one or more embodiments of the invention, STEP 402, STEP 404, STEP 406, STEP 408, and STEP 410 are essentially the same as STEP 202, STEP 204, STEP 206, STEP 208, and STEP 210, respectively, discussed above in reference to FIG. 2.

In STEP 412, a sample brightness factor is calculated for each of the projected coordinates. The sample brightness factor may be calculated using the normal vector of the corresponding control point and a light source model specified in the ED. Specifically, the sample brightness factor may correspond to the dot product of the normal vector and the light source model. If no light source model is specified in the ED, a default light source model may be used.

In STEP 414, sample CCMFs for each of the projected control points are generated based on the sample brightness factors of the corresponding control points. The CCMFs could be, for example, simple scaling factors to apply to each color component of the base color(s). The base color(s) may be specified in the ED. If a base color is not specified in the ED, a default base color may be used.

In STEP 416, multiple polynomials are fit based on the sample CCMFs. For example, in the case of the RGB color model, three polynomials may be fit: one polynomial for modifying the red color component, one polynomial for modifying the green color component, and one polynomial for modifying the blue color component. The resulting polynomial functions may then be used to obtain CCMFs over the entire area of the 2D polygon. The polynomials may be of any type including biquadratic or bicubic polynomial functions. Further, the accuracy of the polynomial fit using known techniques, such as standard deviation, etc.

In STEP 418, CCMFs for multiple pixels of the 2D polygon are obtained by evaluating the multiple polynomials at the multiple pixels. For example, in the case of the RGB color mode, a red CCMF may be obtained for a pixel by evaluating one of the polynomials at the pixel, a green CCMF may be obtained for the pixel by evaluating one of the polynomials at the pixel, and a blue CCMF may be obtained for the pixel by evaluating one of the polynomials at the pixel. The obtained CCMFs are applied to the base color(s) of the pixels. Those skilled in the art, having the benefit of this detailed description, will appreciate that obtaining the CCMFs for the pixels by evaluating the polynomials at the pixels, and then applying the CCMFs to the base color(s) of the pixels, the 3D lighting effect is applied to the 2D polygon.

In STEP 420, the polygon is now a 2D rendering of the 3D shape. Accordingly, the 2D polygon may be output to a screen, a printer, and/or a file.

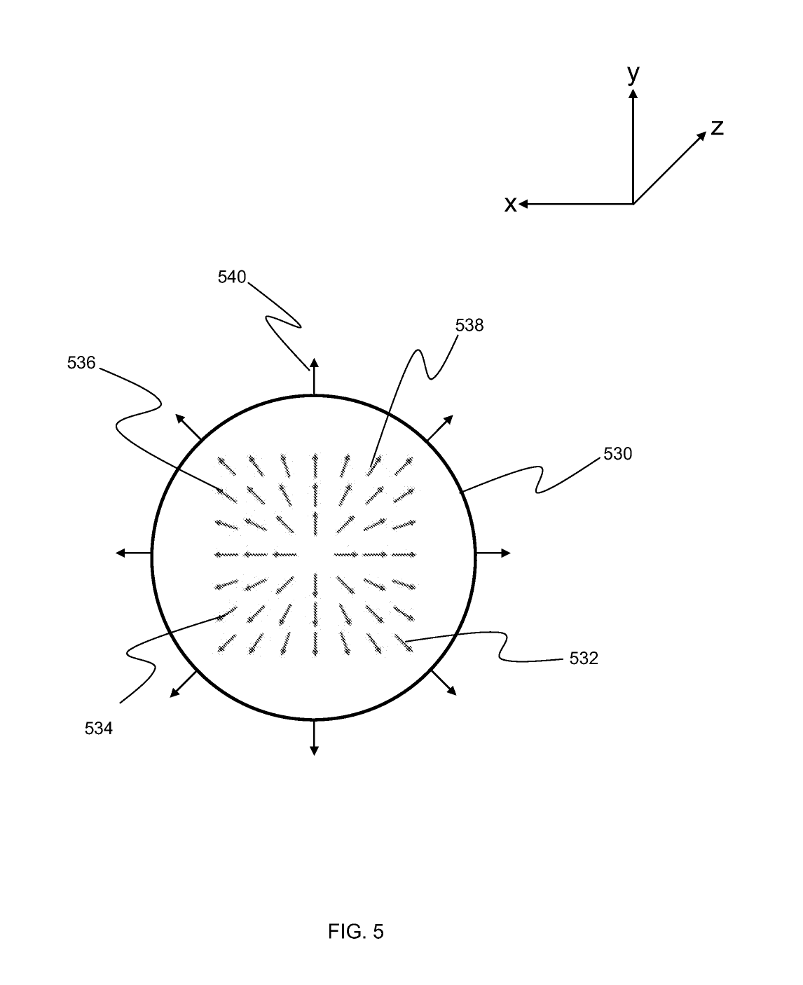

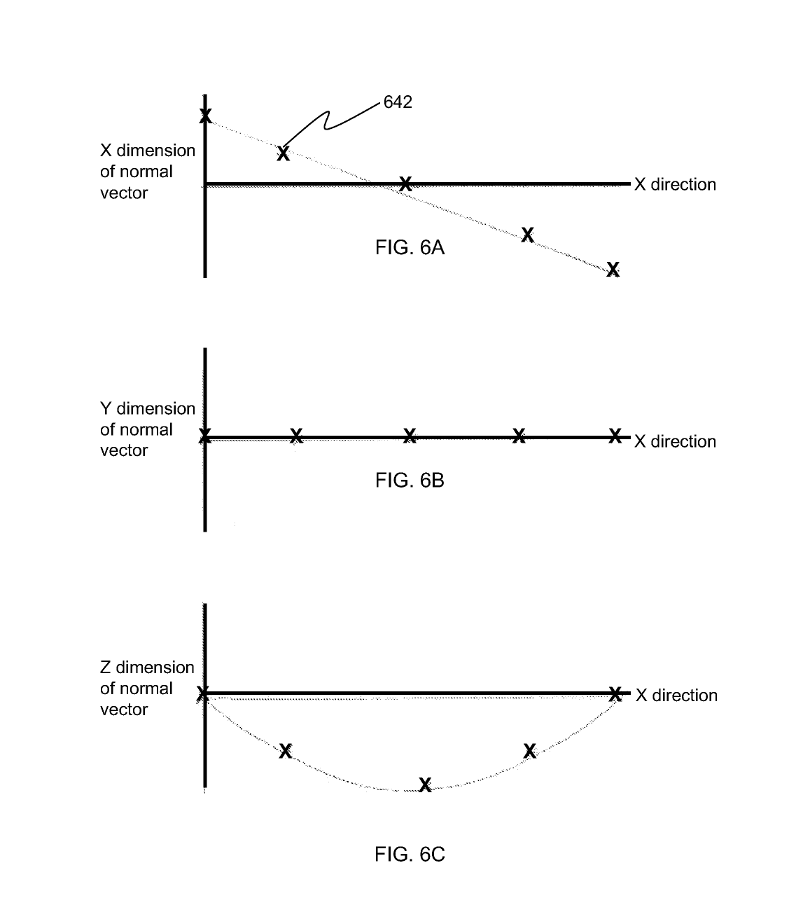

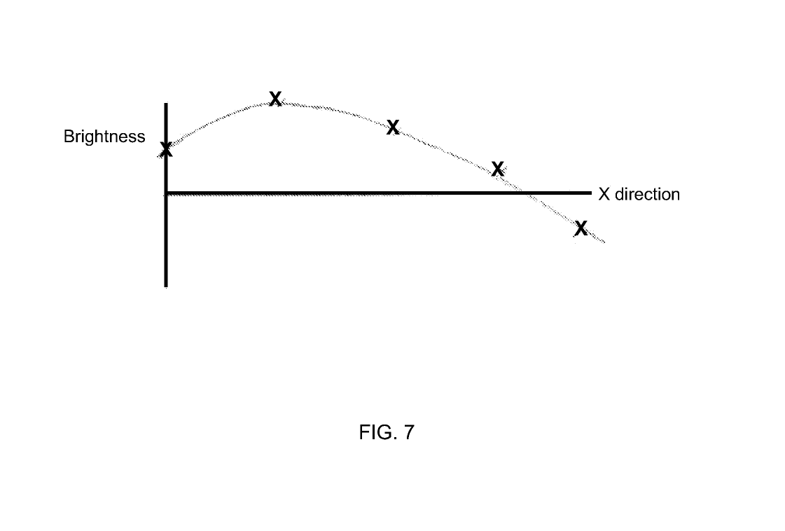

FIG. 5 is an example in accordance with one or more embodiments of the invention. In FIG. 5, assume the 3D shape is a sphere. FIG. 5 shows the 2D polygon projection (530) of the 3D sphere. FIG. 5 exemplifies the results of STEPS 204-208, 304-308, and 404-408 in FIG. 2, FIG. 3, and FIG. 4, respectively. FIG. 5 also shows the normal vectors (532, 534, 536, 538, and 540), where each normal vector shown corresponds to a selected control point. As expected from the sphere example, the normal vectors (e.g., normal vector (532)) in the lower right hand quadrant point down and to the right. The normal vectors in the lower left hand quadrant (e.g., normal vector (534)) point down and to the left. Similarly for the normal vectors on the upper right (e.g., normal vector (538)) and upper left (i.e., normal vector (536)), the normal vectors point up and to the right and left, respectively. FIG. 5 also demonstrates that control points and thus normal vectors (e.g., normal vector (540)) may be selected at the boundary of the 2D polygon projection of the 3D shape. In FIG. 5, approximately 50 control points are shown. However, one of ordinary skill in the art would recognize that this number is excessive in the case of a sphere. In one or more embodiments of the invention, 10-20 control points may be selected. In one or more embodiments, the control points may be selected to be evenly distributed over the 2D polygon projection of the 3D shape. In FIG. 5, a coordinate system of the projected 2D polygon (530), or cross-section of the sphere, is shown where the projected 2D polygon (530) is in the x-y plane, i.e., taken through the equator of the sphere. In FIG. 6, the origin of the coordinate system is considered to be at the center of the 2D polygon.

FIGS. 6A-6C show charts in accordance with one or more embodiments of the invention. FIGS. 6A, 6B, and 6C show the x, y, and z coordinates (dimensions) of the normal vectors as a function of position in the x direction of the 2D polygon. As expected for a sphere, FIG. 6A shows that the x dimension of the normal vector is positive to the left, as in the normal vectors (536) and (534) in FIG. 5, and the x dimension of the normal vector is negative to the right, as in the normal vectors (532) and (538) in FIG. 5. FIG. 6B shows that the y dimension of the normal vector is zero in the x direction of the 2D polygon because the projection was along the equator, i.e., in the x-y plane. FIG. 6C shows the z dimension as a function of position in the x direction of the 2D polygon. The z dimension always points outward from the page with a minimum at the edges in the x direction and a maximum at the center. Examples of the control points (642) are indicated by an “X” in FIGS. 6A-6C.

In one or more embodiments of the invention, a polynomial is fit using the coordinates in the plane of the 2D polygon and one of the components of the normal vector. Because the original 3D normal vectors vary in a smooth manner across the 3D object, a low order polynomial may fit the data well. For example, the polynomials may be linear or quadratic, when considering only the x or y normal components in the 2D polygon and/or bi-linear or bi-quadratic when considering the z normal component in the 2D polygon (as shown in FIGS. 6A-6C).

FIG. 7 is a chart in accordance with one or more embodiments of the invention. FIG. 7 demonstrates brightness factors. As previously described, the surface vectors and a light source model may be used to calculate the brightness factor for the pixels. In the example shown in the FIG. 7, the light source is considered to be to the left and out of the paper towards the viewer at about 45 degrees. As may be expected from a sphere, the brightness factor is greater where the normal vectors are pointing towards the light source and darker where the normal vectors are pointing away from the light source.

In one or more embodiments of the invention, the 2D polygon may be filled with a base color for some or all of the pixels in the 2D polygon. The base color may then be modified based on the brightness factor for the pixel. In the case of using different polynomials for different dimensions of the surface vector, the polynomials for each dimension may be evaluated to get an estimate of the surface vector at each pixel. The normal vector at the pixel may then be used with the light source model to calculate how much brighter or darker the base color of the pixel needs to be to show the 3D lighting effect. Alternatively, the single brightness polynomial may be used and applied in the same manner to calculate how much brighter or darker the base color of the pixel needs to be to show the 3D lighting effect.

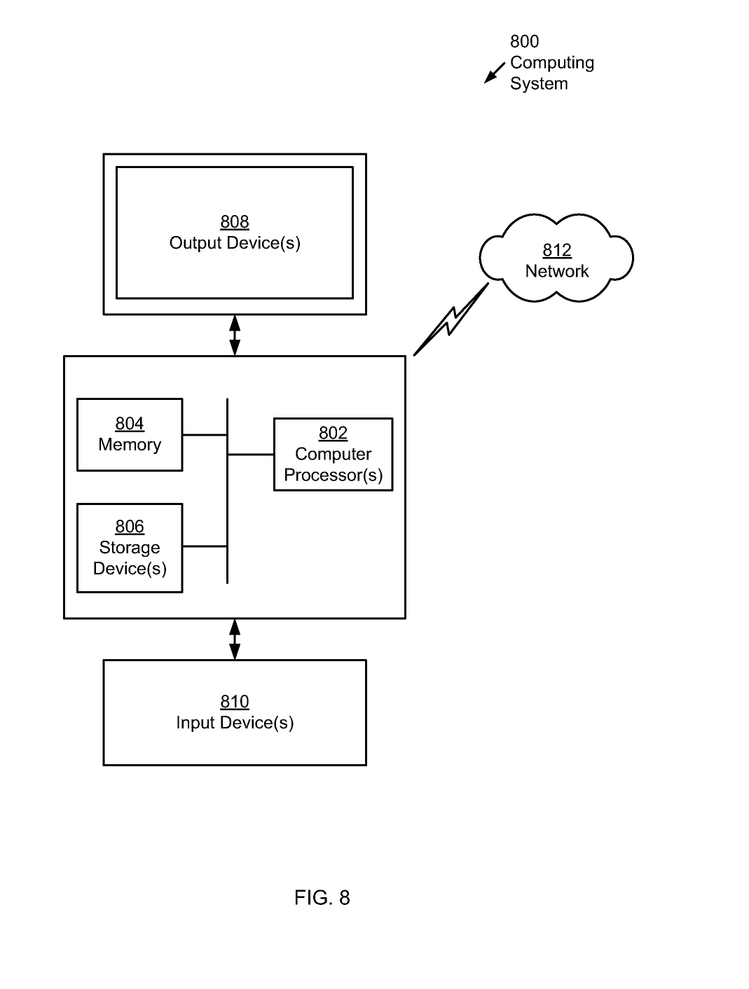

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 8, the computing system (800) may include one or more computer processor(s) (802), associated memory (804) (e.g., random access memory (RAM), cache memory, flash memory, etc.), one or more storage device(s) (806) (e.g., a hard disk, an optical drive such as a compact disk (CD) drive or digital versatile disk (DVD) drive, a flash memory stick, etc.), and numerous other elements and functionalities. The computer processor(s) (802) may be an integrated circuit for processing instructions. For example, the computer processor(s) may be one or more cores, or micro-cores of a processor. The computing system (800) may also include one or more input device(s) (810), such as a touchscreen, keyboard, mouse, microphone, touchpad, electronic pen, or any other type of input device. Further, the computing system (800) may include one or more output device(s) (808), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (800) may be connected to a network (814) (e.g., a local area network (LAN), a wide area network (WAN) such as the Internet, mobile network, or any other type of network) via a network interface connection (not shown). The input and output device(s) may be locally or remotely (e.g., via the network (812)) connected to the computer processor(s) (802), memory (804), and storage device(s) (806). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (800) may be located at a remote location and connected to the other elements over a network (814). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

One or more embodiments of the invention advantageously, eliminate the need for calculating a 3D model with many triangles to represent a smooth simple convex surface. In charts or other 3D objects where many (hundreds or possibly thousands) simple 3D shapes may be requested, eliminating the triangle calculations may provide a significant improvement in efficiency.

While the invention has been described with respect to a limited number of embodiments, those skilled in the art, having benefit of this disclosure, will appreciate that other embodiments may be devised which do not depart from the scope of the invention as disclosed herein. Accordingly, the scope of the invention should be limited only by the attached claims.

What is claimed is:

1. A method for rendering a three-dimensional (3D) shape, comprising:
obtaining an electronic document (ED) specifying the 3D shape;
generating a two-dimensional (2D) polygon by projecting the 3D shape onto a 2D plane;
selecting a plurality of control points on a surface of the 3D shape;
calculating a plurality of normal vectors orthogonal to the surface at the plurality of control points, wherein each of the plurality of normal vectors comprises a first dimension, a second dimension, and a third dimension;
determining a plurality of coordinates by projecting the plurality of control points onto the 2D plane;
fitting a first polynomial based on at least the plurality of coordinates and the plurality of normal vectors;
applying a 3D lighting effect to the 2D polygon based on the first polynomial; and
outputting the 2D polygon with the 3D lighting effect.

2. The method of claim 1, further comprising:
fitting a second polynomial based on the plurality of coordinates and the second dimension of the plurality of normal vectors;
fitting a third polynomial based on the plurality of coordinates and the third dimension of the plurality of normal vectors,
wherein the first polynomial is fit based on the first dimension of the plurality of normal vectors, and
wherein applying the 3D lighting effect is further based on the second polynomial and the third polynomial;
generating a surface vector for a first pixel corresponding to the 2D polygon by evaluating the first polynomial, the second polynomial, and the third polynomial at the first pixel; and
calculating a brightness factor for the first pixel using the surface vector and a light source model,
wherein applying the 3D lighting effect comprises applying the brightness factor for the first pixel to a base color of the first pixel.

3. The method of claim 2, wherein the light source model corresponds to a point source.

4. The method of claim 2, further comprising:
calculating a brightness factor for a second pixel corresponding to the 2D polygon by executing an interpolation based on at least the brightness factor for the first pixel,
wherein applying the 3D lighting effect further comprises applying the brightness factor for the second pixel to the base color of the second pixel.

5. The method of claim 2, wherein:
projecting the 3D shape is based upon a 3D view, and
the ED further specifies at least one selected from a group consisting of the 3D view, the base color of the first pixel, and the light source model.

6. The method of claim 1, further comprising:
calculating a plurality of sample brightness factors at the plurality of coordinates using the plurality of normal vectors and a light source model,
wherein the first polynomial is fit based on the plurality of sample brightness factors; and
calculating a brightness factor for a pixel corresponding to the 2D polygon by evaluating the first polynomial at the pixel,
wherein applying the 3D lighting effect comprises applying the brightness factor to a base color of the pixel.

7. The method of claim 1, further comprising:
calculating a plurality of sample brightness factors at the plurality of coordinates using the plurality of normal vectors and a light source model;
generating, for a projected control point, a plurality of sample color component modification factors based on a sample brightness factor,
wherein the first polynomial is fit based on the projected control point and a first sample color component modification factor of the plurality of sample color component modification factors;
fitting a second polynomial based on the projected control point and a second sample color component modification factor of the plurality of sample color component modification factors; and
fitting a third polynomial based on the projected control point and a third sample color component modification factor of the plurality of sample color component modification factors,
wherein applying the 3D lighting effect comprises selecting a plurality of color value modification factors for a pixel corresponding to the 2D polygon by evaluating the first polynomial, the second polynomial, and the third polynomial at the pixel.

8. A non-transitory computer readable medium (CRM) storing a plurality of instructions for rendering a three-dimension (3D) shape, the instructions comprising functionality for:
obtaining an electronic document (ED) specifying a three-dimensional (3D) shape;
generating a two-dimensional (2D) polygon by projecting the 3D shape onto a 2D plane;
selecting a plurality of control points on a surface of the 3D;
calculating a plurality of normal vectors orthogonal to the surface at the plurality of control points, wherein each of the plurality of normal vectors comprises a first dimension, a second dimension, and a third dimension;
determining a plurality of coordinates by projecting the plurality of control points onto the 2D plane;
fitting a first polynomial based on at least the plurality of coordinates and the plurality of normal vectors;
applying 3D lighting effect to the 2D polygon based on the first polynomial; and
outputting the 2D polygon with the 3D lighting effect.

9. The non-transitory CRM of claim 8, the instructions further comprising functionality for:
fitting a second polynomial based on the plurality of coordinates and the second dimension of the plurality of normal vectors;
fitting a third polynomial based on the plurality of coordinates and the third dimension of the plurality of normal vectors,
wherein the first polynomial is fit based on the first dimension of the plurality of vectors, and
wherein applying the 3D lighting effect is further based on the second polynomial and the third polynomial;
generating a surface vector for a first pixel corresponding to the 2D polygon by evaluating the first polynomial, the second polynomial, and the third polynomial at the first pixel; and
calculating a brightness factor for the first pixel using the surface vector and a light source model,
wherein applying the 3D lighting effect comprising applying the brightness factor for the first pixel to a base color of the first pixel.

10. The non-transitory CRM of claim 9, the instructions further comprising functionality for:
calculating a brightness factor for a second pixel corresponding to the 2D polygon by executing an interpolation based on the brightness factor for the first pixel,
wherein applying the 3D lighting effect further comprises applying the brightness factor for the second pixel to the base color of the second pixel.

11. The non-transitory CRM of claim 9, wherein:
the 3D shape is projected further based upon a 3D view,
the ED further specifies at least one selected from a group consisting of the 3D view, the base color of the first pixel, and the light source model, and
the ED is an Open Office XML (OOXML) file.

12. The non-transitory CRM of claim 8, the instructions further comprising functionality for:
calculating a plurality of sample brightness factors at the plurality of coordinates using the plurality of normal vectors and a light source model,
wherein the first polynomial is fitted based on the plurality of sample brightness factors; and
calculating a brightness factor for a pixel corresponding to the 2D polygon by evaluating the first polynomial at the pixel,
wherein applying the 3D lighting effect comprises applying the brightness factor to a base color of the pixel.

13. The non-transitory CRM of claim 8, the instructions further comprising functionality for:
calculating a plurality of sample brightness factors at the plurality of coordinates using the plurality of normal vectors and a light source model;
generating, for a projected control point, a plurality of sample color component modification factors based on a sample brightness factor,
wherein the first polynomial is fit based on the projected control point and a first sample color component modification factor of the plurality of sample color component modification factors;
fitting a second polynomial based on the projected control point and a second sample color component modification factor of the plurality of sample color component modification factors; and
fitting a third polynomial based on the projected control point and a third sample color component modification factor of the plurality of sample color component modification factors,
wherein applying the 3D lighting effect comprises selecting a plurality of color value modification factors for a pixel corresponding to the 2D polygon by evaluating the first polynomial, the second polynomial, and the third polynomial at the pixel.

14. A system for rendering a three dimensional (3D) shape, comprising:
a computer processor;
a buffer configured to store an electronic document (ED) specifying the ED shape;
a control points module configured to:
generate a two-dimensional (2D) polygon by projecting the 3D shape onto a 2D plane;
determine a plurality of control points on the surface of the 3D shape based on the 2D polygon;
calculate a plurality of normal vectors orthogonal to the surface at the plurality of control points, wherein each of the plurality of normal vectors comprises a first dimension, a second dimension, and a third dimension; and
determine a plurality of coordinates by projecting the plurality of control points onto the 2D plane;
a polynomial engine configured to fit a first polynomial based on at least the plurality of coordinates and the plurality of normal vectors; and
a rendering engine executing on the computer processor and configured to apply a 3D lighting effect to the 2D polygon based on the first polynomial.

15. The system of claim 14, wherein the polynomial engine is further configured to:
fit a second polynomial based on the plurality of coordinates and the second dimension of the plurality of normal vectors; and
fit a third polynomial based on the plurality of coordinates and the third dimension of the plurality of normal vectors,
wherein the first polynomial is fitted based on the first dimension of the plurality of vectors, and
wherein applying the 3D lighting effect is further based on the second polynomial and the third polynomial.

16. The system of claim 15, wherein the rendering engine is further configured to:
generate a surface vector for a pixel corresponding to the 2D polygon by evaluating the first polynomial, the second polynomial, and the third polynomial at the pixel; and
calculate a brightness factor for the pixel using the surface vector and a light source model,
wherein applying the 3D lighting effect comprises applying the brightness factor to a base color of the pixel.

17. The system of claim 14, wherein the control points module is further configured to:
calculate a plurality of sample brightness factors at the plurality of coordinates using the plurality of normal vectors and a light source model,
wherein the first polynomial is fitted based on the plurality of sample brightness factors.

18. The system of claim 17, wherein the rendering engine is further configured to:
calculate a brightness factor for a pixel corresponding to the 2D polygon by evaluating the first polynomial at the pixel,
wherein applying the 3D lighting effect comprises applying the brightness factor to a base color of the pixel.

19. The system of claim 14, wherein the control points module is further configured to:
calculate a plurality of sample brightness factors at the plurality of coordinates using the plurality of normal vectors and a light source model;
generate, for a projected control point, a plurality of sample color component modification factors based on a sample brightness factor,
wherein the first polynomial is fit based on the projected control point and a first sample color component modification factor of the plurality of sample color component modification factors.

20. The system of claim 19, wherein the polynomial engine is further configured to:
fit a second polynomial based on the projected control point and a second sample color component modification factor of the plurality of sample color component modification factors; and
fit a third polynomial based on the projected control point and a third sample color component modification factor of the plurality of sample color component modification factors,
wherein applying the 3D lighting effect comprises selecting a plurality of color value modification factors for a pixel corresponding to the 2D polygon by evaluating the first polynomial, the second polynomial, and the third polynomial at the pixel.
